(19) United States
(12) Patent Application Publication
(10) Pub. No.: US 2006/0266586 A1
(43) Pub. Date: Nov. 30, 2006

(54) Two in one ladder

(76) Inventor: Nick Troiani, Tulare, CA (US)

Correspondence Address: JAMES RAY & ASSOCIATES, 2640 PITCAIRN ROAD, MONROEVILLE, PA, 15146, US

(21) Appl. No.: 11/442,086

(22) Filed: May 26, 2006

Related U.S. Application Data
(60) Provisional application No. 60/684,754, filed on May 26, 2005.

(51) Int. Cl. E06C 1/00

(52) U.S. Cl. 182/169

(57) ABSTRACT

A ladder having five leg members. A first pair of leg members form a front portion and a second pair of leg members disposed behind the front pair are used when the ladder is used as a four legged ladder and a fifth leg member disposed behind and intermediate the second pair of leg members is use when the ladder is used as a three legged ladder. Rung members are disposed between and attached to facing surfaces of such first pair of leg members. The first pair of leg members are rotateably secured to the second pair of leg members and a fifth leg member is disposed intermediate such second pair of leg members.

### CROSS-REFERENCE TO RELATED APPLICATION

This application is related to and claims priority from Provisional Patent Application Ser. No. 60/684,754 filed May 26, 2005.

### FIELD OF THE INVENTION

The present invention relates, in general, to ladders and, more particularly, this invention relates to a step ladder which can be used both inside and outside. Still more specifically, this invention relates to a step ladder which can be converted from a four legged ladder to a three legged ladder depending on the surface such ladder is to be set on.

### BACKGROUND OF THE INVENTION

Prior to the conception and development of the present invention, a number of different types and sizes of ladders have been taught in the prior art and have also used extensively to assist the user to reach high places. Such ladders have generally been four legged type step ladders or two legged type extension ladders. Each of these type ladders come in different sizes to accommodate different heights.

The problem with these type of prior art ladders is that if a job requires different ladder sizes or types then the user must transport a number of ladders to a job site if they are a contractor or if a home owner they must have additional storage space. Additionally, there is added cost incurred to purchase the different size and type of ladders.

Another significant disadvantage of the ladders presently being used, especially for homeowners, is that when being used on uneven surfaces they present a relatively unsafe condition. It is a well known fact, as reported by the United States Consumer Product safety Commission, that there are generally more than 160,000 accidents per year which require treatment that are caused by ladders. More specifically ladders which are being used improperly for the particular surfaces they are being used on. Such surfaces include but are not limited to gravel, soft and/or uneven earth, floors, driveways, etc.

### SUMMARY OF THE INVENTION

The present invention provides a ladder which can be used both indoors and outdoors and which can be converted from a four legged step type ladder into a three legged ladder. Such ladder includes a plurality of leg members. A first pair of such plurality of leg members disposed in a front portion of the ladder and a second pair of such plurality of leg members are disposed behind the front pair of leg members. The second pair of leg members are used when such ladder is used as a four legged ladder and a fifth leg member is disposed behind and intermediate the second pair of leg members for use when the ladder is to be used as a three legged ladder. There are a plurality of rung members disposed between inner oppositely facing surfaces of the first pair of such plurality of leg members. At least some of such plurality of rung members have a different predetermined length, with a longest length rung being disposed nearest the lower portion of the ladder and a shortest length rung being disposed nearest a top portion of such ladder. An attachment means is engageable with each of such plurality of rung members and such first pair of such plurality of leg members for attaching the rung members to the first pair of such plurality of leg members. There is a hinge means disposed adjacent a top portion of such plurality of leg members for securing the first pair of such plurality of leg members disposed in a front portion of the ladder to the second pair of such plurality of leg members disposed behind the front pair of leg members and for hingedly securing the fifth leg member intermediate the second pair of leg members for use when the ladder is to be used as a three legged ladder. The final essential element are a pair of brace means. A first one of such pair of brace means is connected to a first one of such front pair of leg members and a first one of such second pair of leg members and a second one of such pair of brace means is connected to a second one of such front pair of leg members and a second one of such second pair of leg members for maintaining a bottom of each of the first pair of such plurality of leg members disposed in a front portion of such ladder and the second pair of such plurality of leg members disposed behind the front pair of leg members in a spaced relationship when the ladder is being used as a four legged ladder.

### OBJECTS OF THE INVENTION

It is, therefore, one of the primary objects of the present invention to provide a ladder which will substantially minimize the chance of injury caused by the use of an incorrect ladder for the intended purpose.

Another object of the present invention is to provide a ladder which, because it is multi-functional, can reduce the storage space required in a home or the number of ladders which a contractor must take to the job site.

Still another object of the present invention is to provide a ladder which, by being multi-function, will be cost effective.

Yet another object of the present invention is to provide a ladder which is relatively simple to use.

An additional object of the present invention is to provide a ladder which can be used both indoors and outdoors.

A further object of the present invention is to provide a ladder which is relatively simple to manufacture.

In addition to the several objects and advantages of the present invention which have been described with some degree of specificity above, it should be understood that various additional advantages of the invention will become more readily apparent to those persons skilled in the relevant art from the following more detailed description of the invention, particularly, when such description is taken in conjunction with the attached drawing Figures and with the appended claims.

### BRIEF DESCRIPTION OF THE DRAWINGS

FIG. 1 is a side view of a multi-functional ladder according to one embodiment of the present invention where the ladder is used as a standard four legged ladder;

FIG. 2 is a side view of the ladder, shown in FIG. 1, according to a second embodiment of the present invention where the ladder is used as a three legged ladder using a fifth leg attached thereto via a detachable stop means;

FIG. 3 is a side view of the multi-functional ladder, shown in FIGS. 1 and 2, particularly showing the ladder in a closed position for storage until needed;

FIG. 4 is a front view of the multi-functional ladder according to a third embodiment of the invention where the front pair of leg members are substantially straight;

FIG. 5 is a front view of the ladder according to a fourth embodiment of the invention where the front pair of leg members are arcuately shaped adjacent a bottom portion thereof;

FIG. 6 is a side view of the fifth leg of the multi-functional ladder, particularly showing a portion of the rotatable means that connects the fifth leg to the first and second pair of leg members; and

FIG. 7 is a rear view of the fifth leg of the ladder, particularly showing the triangular configuration of the plate like portions of the rotatable means.

### BRIEF DESCRIPTION OF THE PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing Figures.

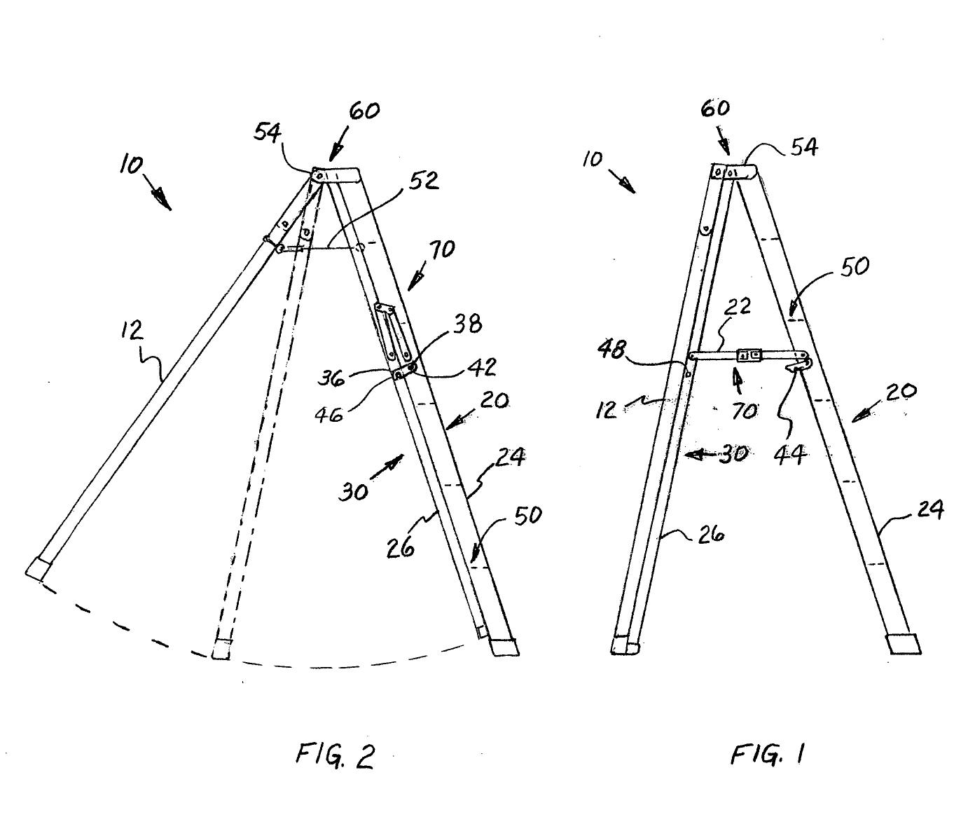

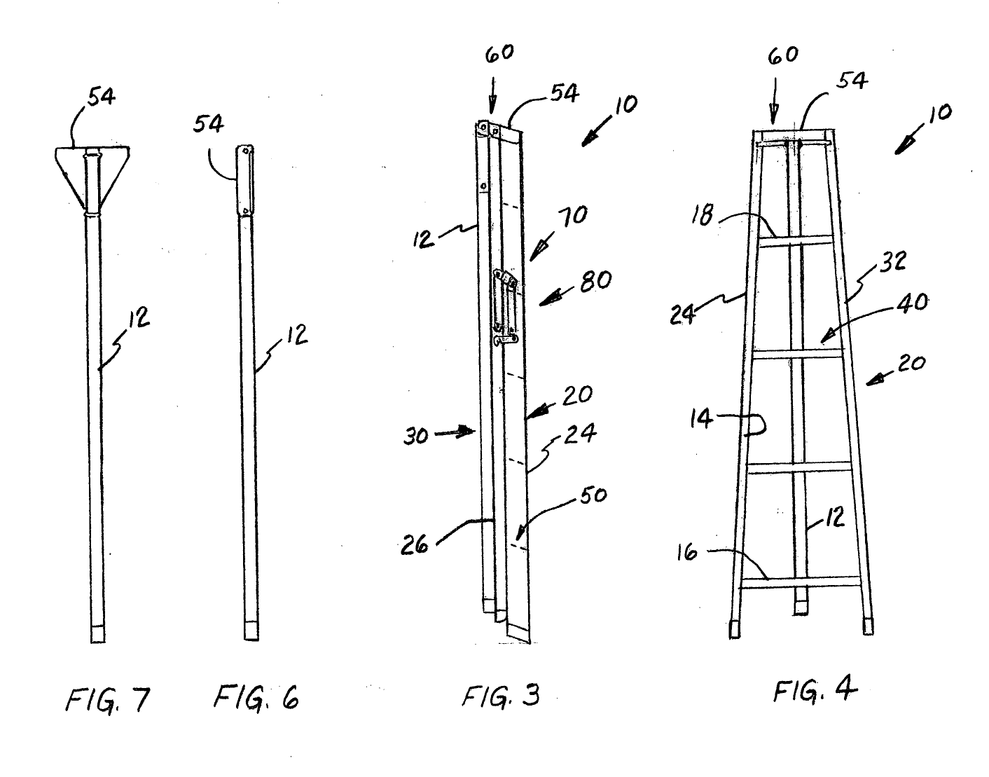

Referring now, more particularly, to FIGS. 1 through 7 of the drawings, there is illustrated a multi-functional ladder, generally designated 10, that can be used both indoors and outdoors. The ladder 10 includes a plurality of leg members produced from a first predetermined material. A first pair of leg members, generally designated 20, are disposed in a front portion of the ladder 10. A second pair of leg members, generally designated 30, are disposed behind the first pair of leg members 20. The second pair of leg members 30 are used when the ladder 10 is to be used as a four legged ladder. A fifth leg member 12 is disposed behind and intermediate the second pair of leg members 30. The fifth leg member 12 is used when such ladder 10 is to be used as a three legged ladder.

The ladder 10 also includes a plurality of rung members, generally designated 40, produced from a second predetermined material. The plurality of rung members 40 are disposed between inner oppositely facing surfaces 14 of the first pair of leg members 20. At least some of the plurality of rung members 40 have a different predetermined length. A longest length rung 16 is disposed nearest a lower portion of the ladder 10 and a shortest length rung 18 is disposed nearest a top portion of such ladder 10. Also, the rung members 40 will, preferably, be spaced about one foot apart.

The multi-functional ladder 10 also has an attachment means, generally designated 50, that is engageable with each of the plurality of rung members 40 and the first pair of leg members 20 for attaching such rung members 40 to such first pair of leg members 20.

Such ladder 10 further includes a rotatable means, generally designated 60, that is disposed adjacent a top portion of such plurality of leg members to secure the first pair of leg members 20 to the second pair of leg members 30. The rotatable means 60 also rotateably secures the fifth leg member 12 intermediate such second pair of leg members 30 for use when such ladder 10 is to be used as a three legged ladder.

The ladder 10 additionally includes a pair of brace means, generally designated 70, for maintaining a bottom of each of the first pair of leg members 20 disposed in a front portion of such ladder 10 and the second pair of leg members 30 disposed behind such first pair of leg members 20 in a spaced relationship when such ladder 10 is being used as a four legged ladder. A first one 22 of such pair of brace means 70 is connected to a first one 24 of the first pair of leg members 20 and a first one 26 of the second pair of leg members 30. A second one (not shown, however, identical to the first one 22 of such pair of brace means 70) of the pair of brace means 70 is connected to a second one 32 of such first pair of leg members 20 and a second one (not shown, however, identical to the first one 26 of the second pair of leg members 30) of such second pair of leg members 30.

In a presently preferred embodiment, the ladder 10 will have a latch means, generally designated 80. A first portion of the latch means 80 will be connected to either a predetermined one of one of the first pair of leg members 20 or a predetermined one of one of the second pair of leg members 30. A second portion of such latch means 80 will be connected to the opposite one of the predetermined one of one of such first pair of leg members 20 and the predetermined one of one of such second pair of leg members 30 that has such first portion attached thereto.

The first portion of the latch means 80 will, preferably, be a plate like member 36. Plate like member 36 will have an aperture 38 therethrough adjacent a first end 42 thereof to enable such plate like member 36 to be rotateably secured to the predetermined one of either the first pair of leg members 20 or the second pair of leg members 30. A notch 44 is cut through a second end 46 of the plate like member 36 for receiving the second portion of such latch means 80 therein.

The second portion of the latch means 80 will, preferably, be a peg like member 48 connected to the opposed one of the predetermined one of such first pair of leg members 20 and the predetermined one of such second pair of leg members 30 that has the plate like member 36 attached thereto. Peg like member 48 is engageable with the notch 44 of plate like member 36 when the ladder 10 is to be used as a three legged ladder.

In another presently preferred embodiment, the ladder 10 will include a detachable cable stop 52 that is engageable adjacent an upper end of such ladder 10 when used as a three legged ladder.

In one embodiment of the ladder 10, best seen in FIG. 4, the first pair of leg members 20 disposed in the front portion of such ladder 10 will be substantially straight.

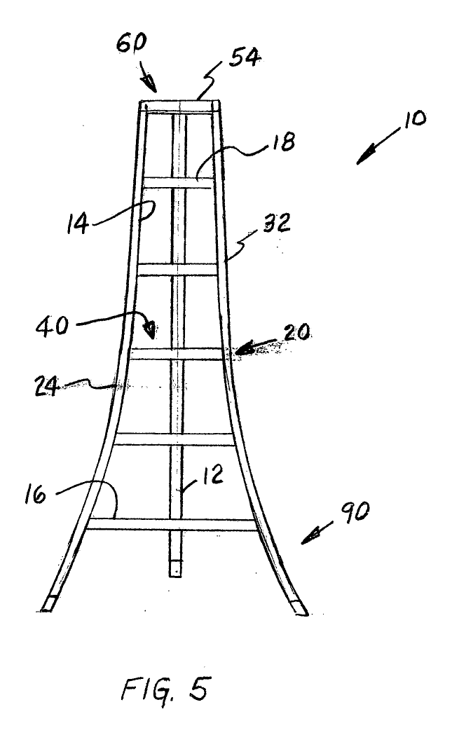

In another embodiment of the ladder 10, as best seen in FIG. 5, the first pair of leg members 20 will include an arcuately shaped portion, generally designated 90, adjacent a bottom portion thereof.

The first predetermined material used to make the plurality of leg members and the second predetermined material used to make the rung members 40 is selected from a group consisting of various types of plastic, wood and metal.

In one embodiment of the ladder 10, the first predetermined material and the second predetermined material will be metal. The metal is, preferably, aluminum.

The attachment means 50 used to attach the rung members 40 to the first pair of leg members 20 is one of welding, bolts, screws and rods.

Finally, the rotatable means 60 includes a pair of plate like portions 54 having a predetermined configuration disposed adjacent the upper end of such ladder 10 and on opposed sides thereof. As best seen in FIG. 7, the predetermined configuration of the pair of plate like portions 54 is, preferably, generally triangular.

While in accordance with the patent statutes a presently preferred embodiment as well as a number of alternative embodiments of the present invention have been described in sufficient detail above to enable a person skilled in the relevant art to make and use the invention, it should be understood that various modifications and other adaptations can be envisioned for the invention without departing from either the spirit of the invention or the scope of the appended claims.

I claim:

1. A ladder which can be adapted to be a multi-functional ladder for use both indoors and outdoors, said ladder comprising:
(a) a plurality of leg members produced from a first predetermined material, a first pair of said plurality of leg members disposed in a front portion of said ladder, a second pair of said plurality of leg members disposed behind said first pair of leg members, said second pair of leg members to be used when said ladder is used as a four legged ladder and a fifth leg member disposed behind and intermediate said second pair of leg members for use when said ladder is to be used as a three legged ladder;
(b) a plurality of rung members produced from a second predetermined material are disposed between inner oppositely facing surfaces of said first pair of said plurality of leg members, at least some of said plurality of rung members having a different predetermined length with a longest length rung being disposed nearest a lower portion of said ladder and a shortest length rung being disposed nearest a top portion of said ladder;
(c) an attachment means engageable with each of said plurality of rung members and said first pair of said plurality of leg members for attaching said rung members to said first pair of said plurality of leg members;
(d) a rotatable means disposed adjacent a top portion of said plurality of leg members for securing said first pair of said plurality of leg members disposed in a front portion of said ladder to said second pair of said plurality of leg members disposed behind said front pair of leg members and for rotateably securing said fifth leg member intermediate said second pair of leg members for use when said ladder is to be used as a three legged ladder; and
(e) a pair of brace means, a first one of said pair of brace means connected to a first one of said first pair of leg members and a first one of said second pair of leg members and a second one of said pair of brace means connected to a second one of said first pair of leg members and a second one of said second pair of leg members for maintaining a bottom of each of said first pair of said plurality of leg members disposed in a front portion of said ladder and said second pair of said plurality of leg members disposed behind said first pair of leg members in a spaced relationship when said ladder is being used as a four legged ladder.

2. A ladder, according to claim 1, wherein said ladder further includes a latch means having a first portion connected to a predetermined one of one of said first pair of said plurality of leg members and said second pair of said plurality of leg members and a second portion connected to an opposed one of said predetermined one of one of said first pair of said plurality of leg members and said second pair of said plurality of leg members.

3. A ladder, according to claim 2, wherein said first portion of latch means is a plate like member having each of an aperture therethrough adjacent a first end thereof for enabling said plate like member to be rotateably secured to said predetermined one of said first pair of said plurality of leg members and said second pair of said plurality of leg members, a notch is cut through a second end of said plate like member for receiving said second portion of said latch means therein.

4. A ladder, according to claim 3, wherein said second portion of said latch means is a peg like member connected to an opposed one of said predetermined one of said first pair of said plurality of leg members and said second pair of said plurality of leg members.

5. A ladder, according to claim 1, wherein said ladder further includes a detachable cable stop engageable adjacent an upper end of said ladder.

6. A ladder, according to claim 1, wherein said first pair of said plurality of leg members disposed in said front portion of said ladder include an arcuately shaped portion adjacent a bottom portion thereof.

7. A ladder, according to claim 1, wherein said first pair of said plurality of leg members disposed in said front portion of said ladder are substantially straight.

8. A ladder, according to claim 1, wherein said rungs are spaced about one foot apart.

9. A ladder, according to claim 1, wherein said first predetermined material and said second predetermined material are selected from a group consisting of plastic, wood and metal.

10. A ladder, according to claim 9, wherein said first predetermined material and said second predetermined material are wood and said attachment means engageable with each of said plurality of rung members and said first pair of said plurality of leg members for attaching said rung members to said first pair of said plurality of leg members are one of bolts, screws and rods.

11. A ladder, according to claim 9, wherein said first predetermined material and said second predetermined material are metal and said attachment means engageable with each of said plurality of rung members and said first pair of said plurality of leg members for attaching said rung members to said first pair of said plurality of leg members is one of welding and bolts.

12. A ladder, according to claim 11, wherein said metal is aluminum.

13. A ladder, according to claim 9, wherein said first predetermined material and said second predetermined material are different.

14. A ladder, according to claim 1, wherein said rotatable means includes a pair of plate like portions having a predetermined configuration disposed adjacent said upper end of said ladder and on opposed sides thereof.

15. A ladder, according to claim 14, wherein said predetermined configuration of said pair of plate like portions is generally triangular.
